(19) United States
(12) Patent Application Publication
(10) Pub. No.: US 2007/0046828 A1
(43) Pub. Date: Mar. 1, 2007

(54) Video signal processing apparatus and video signal processing method

(76) Inventor: Hirotoshi Miyazawa, Fukaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/508,229

(22) Filed: Aug. 23, 2006

(30) Foreign Application Priority Data
Aug. 30, 2005 (JP) 2005-249784

(51) Int. Cl. H04N 5/14; H04N 5/202

(52) U.S. Cl. 348/674; 348/672

(57) ABSTRACT

According to one embodiment, a video signal processing apparatus includes an obtaining unit which obtains histogram data for each luminance level of one frame of a luminance signal, a frequency distribution unit which distributes a frequency of a histogram data among the obtained histogram data, the histogram data being greater than a predetermined value, in a luminance level range which is set in advance for each luminance level, and adds the distributed frequency to the original histogram data and thereby obtains corrected histogram data, and a creation unit which creates a table for a nonlinear correction process to be used when performing a nonlinear correction process on the luminance signal based on the corrected histogram data.

### CROSS-REFERENCE TO RELATED APPLICATIONS

This application is based upon and claims the benefit of priority from Japanese Patent Application No. 2005-249784, filed Aug. 30, 2005, the entire contents of which are incorporated herein by reference.

### BACKGROUND

1. Field

One embodiment of the present invention relates to an improvement in a video signal processing apparatus and a video signal processing method, in which a tone correction process is performed on a luminance signal based on a luminance histogram.

2. Description of the Related Art

As is known, in recent years, flat-panel large screen displays have been developed and put into practical use in color television broadcast receiving apparatuses and the like. In this type of large screen display, in order to show a display video clearly, a tone correction process is performed on luminance components of a video signal.

Particularly, in the current basic tone correction process using a luminance histogram, a luminance input/output conversion parameter is created by performing a cumulative addition of histogram data obtained for luminance levels from a lower luminance level.

In such a tone correction process, however, when information is locally concentrated at a particular luminance level, the luminance slope of a concentrated portion may become excessively steep, and in contrast to this, in a portion where there is no information there may be almost no luminance slope.

In view of this, at present, upper and lower limits are set for obtained histogram data; however, this is a simple round-down, padding process and thus tends to be less effective for original intended information.

In the specification of U.S. Pat. No. 6,148,103, there is disclosed a configuration in which when histogram data is locally concentrated at a particular luminance level, the concentrated histogram data is distributed around the particular luminance level.

In the specification of U.S. Pat. No. 6,148,103, however, brightness is not considered upon distributing the concentrated histogram data around the particular luminance level, and thus fluctuations in brightness occur in a display video when its brightness does not match an input video.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a configuration block diagram showing an embodiment of the present invention and for describing a video signal processing system of a television broadcast receiving apparatus;

FIG. 2 is a configuration block diagram for describing the detail of a video signal processing unit of the television broadcast receiving apparatus, according to the embodiment;

FIG. 3 is a configuration block diagram for describing the detail of a signal correction unit of the video signal processing unit according to the embodiment;

FIG. 4 is a configuration block diagram for describing the detail of a luminance nonlinear correction processing unit of the signal correction unit according to the embodiment;

FIG. 5 is a flowchart for describing a processing operation of the luminance nonlinear correction processing unit according to the embodiment;

FIG. 6 is a graph for describing histogram data for one frame which is obtained by the luminance nonlinear correction processing unit according to the embodiment;

FIGS. 7 and 8 are graphs each for describing an exemplary frequency conversion processing operation of the luminance nonlinear correction processing unit according to the embodiment;

FIGS. 9 and 10 are graphs each for describing another exemplary frequency conversion processing operation of the luminance nonlinear correction processing unit according to the embodiment; and

FIG. 11 is a graph for describing a luminance nonlinear correction process performed by the luminance nonlinear correction processing unit according to the embodiment.

### DETAILED DESCRIPTION

Various embodiments according to the invention will be described hereinafter with reference to the accompanying drawings. In general, according to one embodiment of the invention, a video signal processing apparatus includes an obtaining unit which obtains histogram data for each luminance level of one frame of a luminance signal; a frequency distribution unit which distributes a frequency of a histogram data among the obtained histogram data, the histogram data being greater than a predetermined value, in a luminance level range which is set in advance for each luminance level, and adds the distributed frequency to the original histogram data and thereby obtains corrected histogram data; and a creation unit which creates a table for a nonlinear correction process to be used when performing a nonlinear correction process on the luminance signal based on the corrected histogram data.

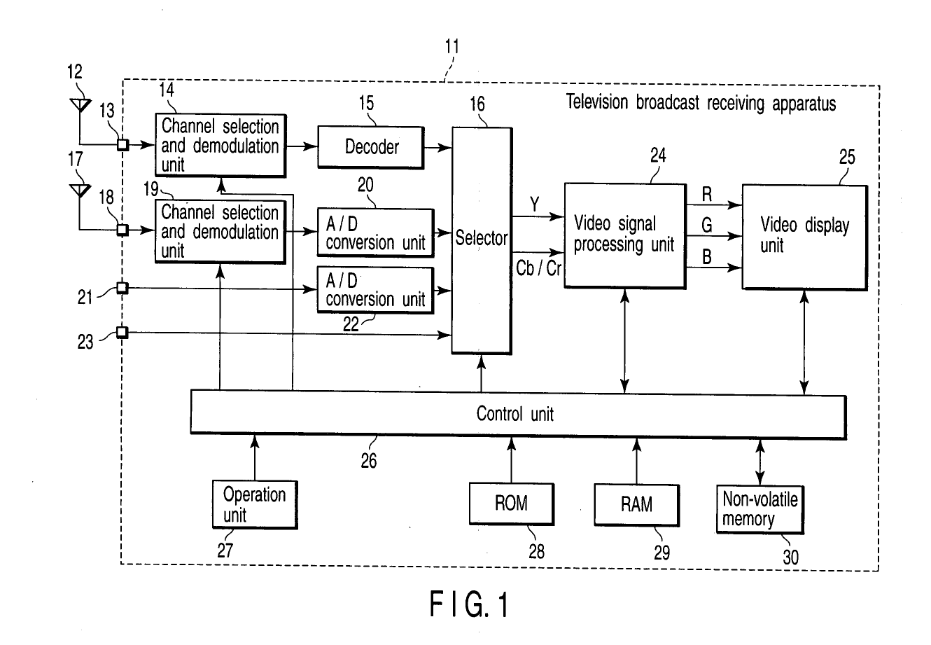

FIG. 1 is a diagram schematically showing a video signal processing system of a television broadcast receiving apparatus 11 which will be described in the embodiment.

Specifically, digital television broadcast signals received by an antenna 12 for receiving digital television broadcasts are supplied to a channel selection and demodulation unit 14 through an input terminal 13. The channel selection and demodulation unit 14 selects a broadcast signal of a desired channel from the input digital television broadcast signals, demodulates the selected signal, and outputs the demodulated signal to a decoder 15.

The decoder 15 then performs a decoding process on the signal input from the channel selection and demodulation unit 14 and thereby generates a digital luminance signal Y and digital color signals Cb/Cr and outputs the generated signals to a selector 16.

Analog television broadcast signals received by an antenna 17 for receiving analog television broadcasts are supplied to a channel selection and demodulation unit 19 through an input terminal 18. The channel selection and demodulation unit 19 selects a broadcast signal of a desired channel from the input analog television broadcast signals, demodulates the selected signal, and generates an analog luminance signal Y and analog color signals Cb/Cr.

Then, the analog luminance signal Y and the analog color signals Cb/Cr generated by the channel selection and demodulation unit 19 are supplied to an A/D (analog/digital) conversion unit 20, converted into a digital luminance signal Y and digital color signals Cb/Cr, and then the digital luminance signal Y and the digital color signals Cb/Cr are output to the selector 16.

An analog luminance signal Y and analog color signals Cb/Cr supplied to an external input terminal 21 for analog video signals are supplied to an A/D conversion unit 22, converted into a digital luminance signal Y and digital color signals Cb/Cr, and then the digital luminance signal Y and the digital color signals Cb/Cr are output to the selector 16. Furthermore, a digital luminance signal Y and digital color signals Cb/Cr supplied to an external input terminal 23 for digital video signals are directly supplied to the selector 16.

Here, the selector 16 selects one from each of the digital luminance signals Y and the digital color signals Cb/Cr supplied from the decoder 15, the A/D conversion units 20 and 22, and the external input terminal 23, and then supplies the selected signals to a video signal processing unit 24.

The video signal processing unit 24 (a detailed description will be described later) performs a predetermined signal process on the input digital luminance signal Y and digital color signals Cb/Cr, thereby generating R (red), G (green), and B (blue) signals.

The R, G, and B signals generated by the video signal processing unit 24 are then supplied to a video display unit 25 and thereby video display is provided. For the video display unit 25, for example, a flat-panel display such as a liquid crystal display or a plasma display is used.

In the television broadcast receiving apparatus 11, various operations including the above-described various reception operations are integrally controlled by a control unit 26. The control unit 26 is a microprocessor which includes a central processing unit (CPU) and the like. The control unit 26 receives operation information from an operation unit 27 including a remote controller (not shown) and, in response thereto, controls each unit such that the content of the operation is reflected.

In this case, the control unit 26 mainly uses a read only memory (ROM) 28 having stored therein a control program executed by the CPU, a random access memory (RAM) 29 for providing a work area to the CPU, and a non-volatile memory 30 in which various setting information, control information, and the like are stored.

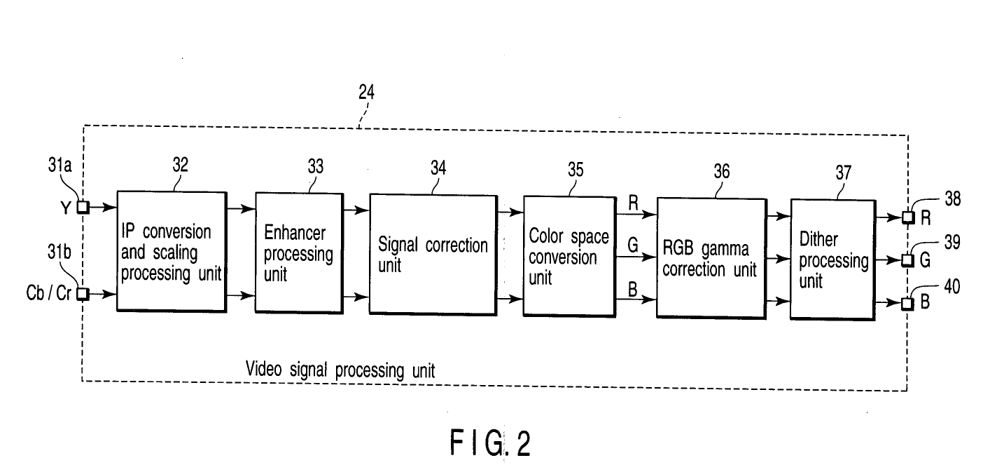

FIG. 2 is a diagram showing an example of the video signal processing unit 24. Specifically, the digital luminance signal Y and the digital color signals Cb/Cr selected by the selector 16 are supplied to an interlace progressive (IP) conversion and scaling processing unit 32 through input terminals 31a and 31b.

The IP conversion and scaling processing unit 32 performs a progressive conversion process and a scaling process on the input luminance signal Y and color signals Cb/Cr in order to provide display on the video display unit 25 (a flat-panel display such as a liquid crystal display or a plasma display), and outputs the processed signals to an enhancer processing unit 33.

The enhancer processing unit 33 performs an enhancer process, in which vertical and horizontal edges are made steep or sharpness is changed, on the input luminance signal Y and color signals Cb/Cr and outputs the processed signals to a signal correction unit 34.

The signal correction unit 34 performs a nonlinear correction process for tone correction on the input luminance signal Y and performs, along with the nonlinear correction process, an amplitude control process on the color signals Cb/Cr and then outputs the processed signals to a color space conversion unit 35.

The color space conversion unit 35 converts the input luminance signal Y and color signals Cb/Cr into R, G, and B signals and outputs the R, G, and B signals to an RGB gamma correction unit 36. The RGB gamma correction unit 36 performs a white balance adjustment on the input R, G, and B signals and performs a gamma correction process on the video display unit 25 and then outputs the R, G, and B signals to a dither processing unit 37.

The dither processing unit 37 performs on the input R, G, and B signals a compression process of converting a high-tone bit expression, in which the number of bits is expanded to increase the representational power, into a number of bits for a low tone corresponding to the video display unit 25, and then outputs the processed R, G, and B signals to the video display unit 25 through output terminals 38, 39, and 40.

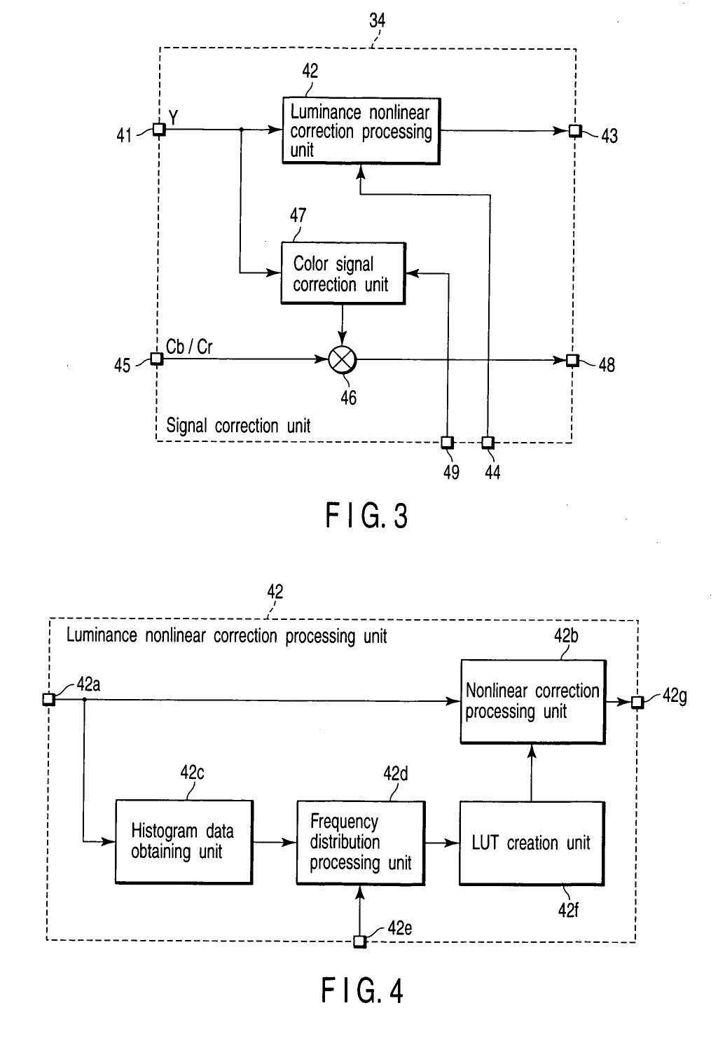

FIG. 3 is a diagram showing an example of the signal correction unit 34. Specifically, the luminance signal Y output from the enhancer processing unit 33 is supplied to a luminance nonlinear correction processing unit 42 through an input terminal 41. The luminance nonlinear correction processing unit 42 performs a nonlinear correction process for tone correction on the luminance signal Y and then outputs the processed luminance signal Y to the color space conversion unit 35 through an output terminal 43.

Here, the luminance nonlinear correction processing unit 42 (a detailed description will be described later) creates a look up table (LUT) for a luminance nonlinear correction process, based on control data which is supplied from the control unit 26 through a control terminal 44, and performs a nonlinear correction process on the luminance signal Y based on the LUT.

The color signals Cb/Cr output from the enhancer processing unit 33 are supplied to a multiplier 46 through an input terminal 45 and multiplied by a color correction signal which is output from a color signal correction unit 47, whereby the color signals Cb/Cr are subjected to an amplitude control process. Then, the processed color signals Cb/Cr are output to the color space conversion unit 35 through an output terminal 48.

The color signal correction unit 47 searches a LUT for a color correction process which is supplied from the control unit 26 through a control terminal 49, for a color correction signal which serves as color gain for performing amplitude control on the color signals Cb/Cr, based on the level of the luminance signal Y supplied to the input terminal 41, and then outputs the color correction signal to the multiplier 46.

FIG. 4 is a diagram showing the detail of the luminance nonlinear correction processing unit 42. Specifically, the luminance signal Y supplied to the input terminal 41 is supplied, through an input terminal 42a, to a nonlinear correction processing unit 42b and to a histogram data obtaining unit 42c. The histogram data obtaining unit 42c obtains histogram data for each luminance level of one frame of the input luminance signal.

The histogram data obtained by the histogram data obtaining unit 42c is supplied to a frequency distribution processing unit 42d. The frequency distribution processing unit 42d (a detailed description will be described later) performs a frequency distribution process on the input histogram data based on control data which is supplied from the control unit 26 through the control terminals 44 and 42e, and outputs the processed histogram data to a LUT creation unit 42f.

The LUT creation unit 42f creates a LUT for a luminance nonlinear correction process, based on the histogram data subjected to a frequency distribution process and output from the frequency distribution processing unit 42d, and then outputs the LUT to the nonlinear correction processing unit 42b. The nonlinear correction processing unit 42b performs a nonlinear correction process on the input luminance signal based on the LUT and outputs the processed luminance signal to the color space conversion unit 35 through an output terminals 42g and 43.

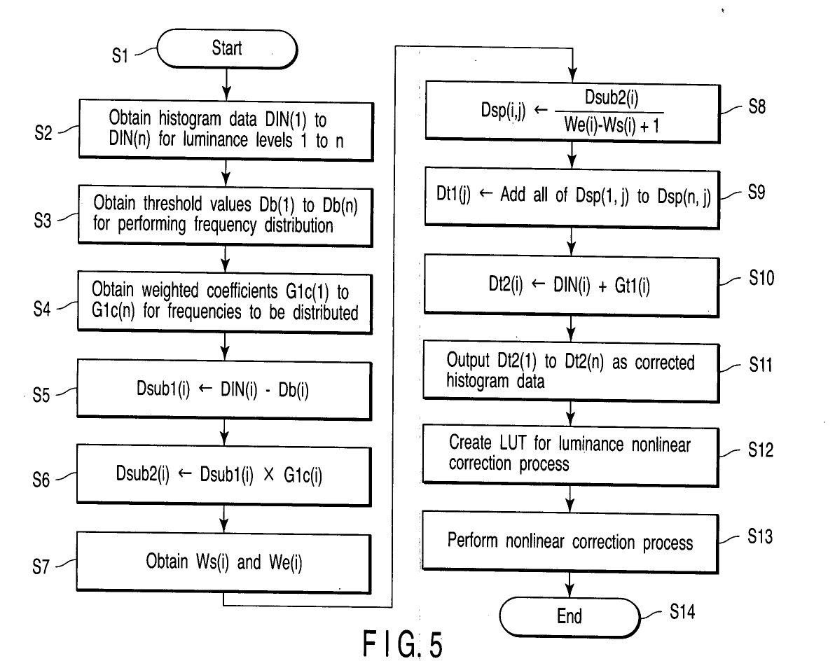

FIG. 5 is a flowchart summarizing an exemplary nonlinear correction processing operation which is performed on a luminance signal Y by the luminance nonlinear correction processing unit 42. Specifically, when the process starts (block S1), the histogram data obtaining unit 42c obtains, in block S2, histogram data DIN (1) to DIN (n) for luminance levels 1 to n.

The histogram data is obtained by dividing the dynamic range of the luminance levels into n parts and counting the number of pixels in one frame of a video signal, which have the luminance levels 1 to n. In this case, it is assumed that the resolving power of the luminance levels 1 to n is set precisely. For example, when an input vide signal is 8 bits, the resolving power of the luminance levels upon obtaining histogram data is also set to 8 bits.

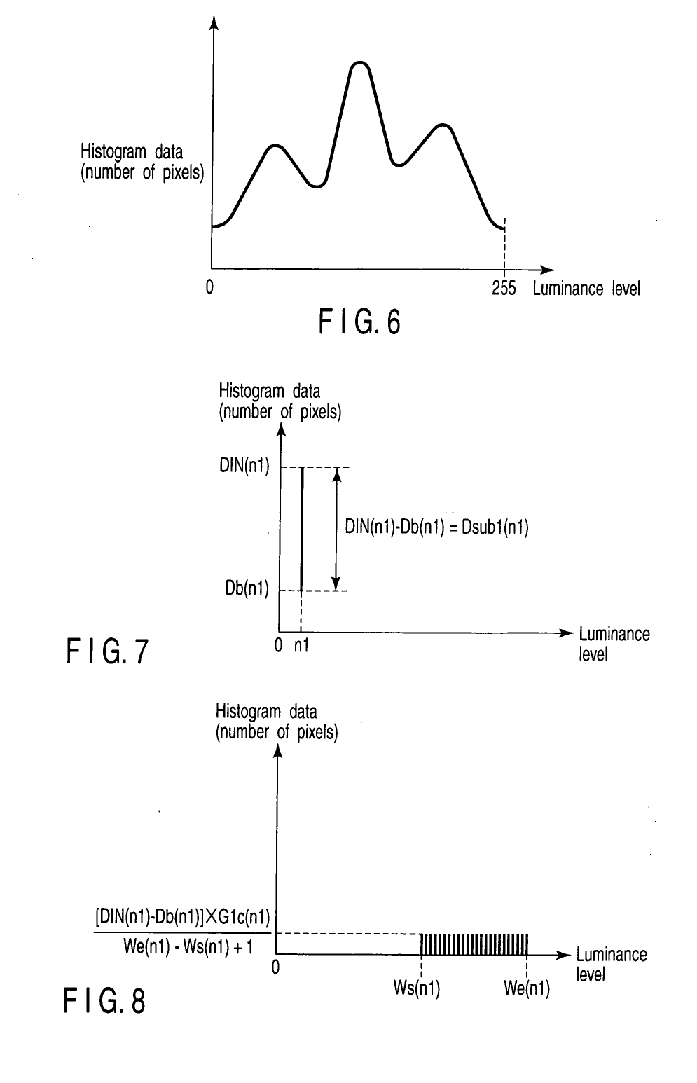

FIG. 6 is a graph showing exemplary luminance histogram data for one frame obtained in the above-described manner. In this case, the resolving power of the luminance levels is 8 bits (0 to 255). That is, the number of pixels for each of 256 luminance levels, from 0 to 255, is obtained. Thus, by adding all the number of pixels at each brightness level, it adds up to the number of pixels for one frame held by the input video signal.

Thereafter, the frequency distribution processing unit 42d performs a frequency distribution process on the obtained histogram data DIN (1) to DIN (n) based on control data which is supplied from the control unit 26.

First, the frequency distribution processing unit 42d obtains, in block S3, threshold values Db (1) to Db (n) for performing a frequency distribution on the histogram data DIN (1) to DIN (n) for the luminance levels 1 to n.

The threshold values Db (1) to Db (n) are arbitrarily set in advance for each of the luminance levels 1 to n and stored in the non-volatile memory 30. The threshold values are read by the control unit 26 when necessary, and supplied, as part of control data, to the frequency distribution processing unit 42d through the control terminals 44 and 42e.

Then, the frequency distribution processing unit 42d obtains, in block S4, weighted coefficients Glc (1) to Glc (n) for frequencies to be distributed at the luminance levels 1 to n. The weighted coefficients Glc (1) to Glc (n) are also arbitrarily set in advance for each of the luminance levels 1 to n and stored in the non-volatile memory 30. The weighted coefficients are read by the control unit 26 when necessary, and supplied, as part of control data, to the frequency distribution processing unit 42d through the control terminals 44 and 42e.

Thereafter, the frequency distribution processing unit 42d subtracts, in block S5, a threshold value Db (i) (i=1 to n) from histogram data DIN (i), i.e., the following calculation is performed:
Dsub1(i)=DIN(i)−Db(i),

whereby the subtracted value Dsub1 (i) is calculated. Note that if the subtraction result is negative, the Dsub1 (i) is set to 0.

Then, in block S6, the frequency distribution processing unit 42d multiplies the subtracted value Dsub1 (i) by a weighted coefficient Glc (i), i.e., the following calculation is performed:
Dsub2(i)=Dsub1(i)×Glc(i),

whereby the multiplied value Dsub2 (i) is calculated. The calculation processes in blocks S5 and S6 are performed on each of the luminance levels 1 to n.

In block S7, the frequency distribution processing unit 42d specifies a range in which the multiplied value Dsub2 (i) is to be distributed as a histogram correction. Specifically, the frequency distribution processing unit 42d obtains a frequency distribution development start value Ws (i) and a frequency distribution development end value We (i). The frequency distribution development start value Ws (i) and the frequency distribution development end value We (i) are also arbitrarily set in advance for each of the luminance levels 1 to n and stored in the non-volatile memory 30. The frequency distribution development start value Ws (i) and the frequency distribution development end value We (i) are read by the control unit 26 when necessary, and supplied, as part of control data, to the frequency distribution processing unit 42d through the control terminals 44 and 42e. Note that the frequency distribution development start value Ws (i) and the frequency distribution development end value We (i) are set such that We (i)>Ws (i). Note also that, in the present embodiment, the corrected histogram is the same as the input histogram divided into n parts and thus the Ws (i) and the We (i) take a value of 1 to n.

Subsequently, the frequency distribution processing unit 42d performs, in block S8, a frequency distribution process and stores a calculation result in Dsp (i, j) (i and j are both 1 to n). Specifically, the frequency distribution processing unit 42d performs the following calculation:
Dsp(i,j)=Dsub2(i)/[We(i)−Ws(i)+1],

and the calculation result is stored in Dsp (i, j) where j (1 to n)=Ws (i) to We (i), and 0 is stored in Dsp (i, j) where j≠Ws (i) to We (i). When Dsub2 (i)=0, 0 is stored in the whole range where j=1 to n. The calculation process in block S8 is performed on each of the luminance levels 1 to n.

FIGS. 7, 8, 9 and 10 are characteristic graphs of histogram data each showing the above-described frequency distribution process. First, as shown in FIG. 7, when large histogram data DIN (n1) is present at a low luminance level n1, a threshold value Db (n1) set for the luminance level n1 is subtracted from the histogram data DIN (n1), whereby a subtracted value Dsub1 (n1) is obtained.

Thereafter, as shown in FIG. 8, the subtracted value Dsub1 (n1) is multiplied by a weighted coefficient Glc (n1) set for the luminance level n1 and a multiplied value Dsub2 (n1) is divided by [We (n1)−Ws (n1)+1], whereby a frequency is obtained. The frequency is distributed in a range from a frequency distribution development start value Ws (n1) to a frequency distribution development end value We (n1) which are set for the luminance level n1. In this case, the Ws (n1) to the We (n1) for the luminance level n1 are set in a range where the luminance level is high, which means that the frequency at a high luminance increases, and therefore, the original display portion of the luminance level n1 can be darkened.

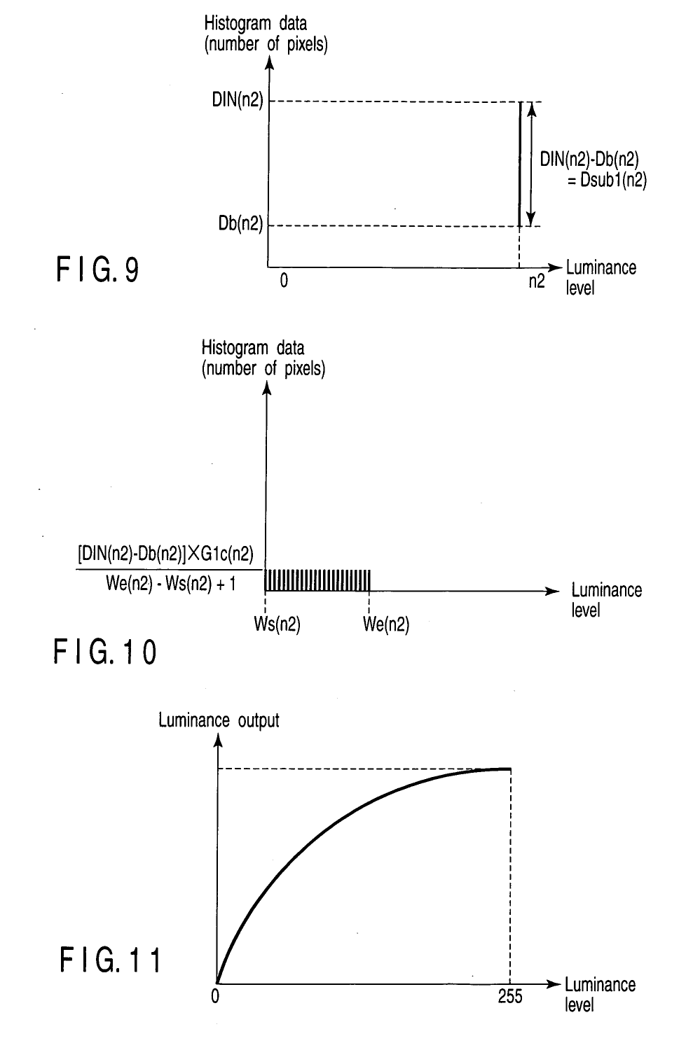

As shown in FIG. 9, when large histogram data DIN (n2) is present at a high luminance level n2, a threshold value Db (n2) set for the luminance level n2 is subtracted from the histogram data DIN (n2), whereby a subtracted value Dsub1 (n2) is obtained.

Thereafter, as shown in FIG. 10, the subtracted value Dsub1 (n2) is multiplied by a weighted coefficient Glc (n2) set for the luminance level n2 and a multiplied value Dsub2 (n2) is divided by [We (n2)−Ws (n2)+1], whereby a frequency is obtained. The frequency is distributed in a range from a frequency distribution development start value Ws (n2) to a frequency distribution development end value We (n2) which are set for the luminance level n2. In this case, the Ws (n2) to the We (n2) for the luminance level n2 are set in a range where the luminance level is low, which means that the frequency at a low luminance increases, and therefore, the original display portion of the luminance level n2 can be brightened.

Subsequently, in block S9, the frequency distribution processing unit 42d adds all values of Dsp (1, j) to Dsp (n, j) based on calculation results obtained in the frequency distribution process, and stores an added value in Dt1 (j). The calculation process in block S9 is also performed on each luminance level (j=1 to n).

Then, in block S10, the frequency distribution processing unit 42d adds the added value Dt1 (i) to the first obtained histogram data DIN (i), whereby an added value Dt2 (i) is obtained. In block S11, the frequency distribution processing unit 42d outputs added values Dt2 (1) to Dt2 (n) as corrected histogram data.

In block S12, the LUT creation unit 42f performs a cumulative addition of the corrected histogram data from a lower luminance level, and thereby creates a luminance input/output conversion parameter, that is, a LUT for a luminance nonlinear correction process. Then, in block S13, the nonlinear correction processing unit 42b performs a nonlinear correction process on the luminance signal Y based on the LUT and then the process ends (block S14). FIG. 11 is a graph showing exemplary nonlinear characteristics which are provided to the luminance signal Y by the LUT for a luminance nonlinear correction process.

According to the present embodiment, a frequency distribution process is performed on histogram data for luminance levels within a luminance level range which can be arbitrarily set for each luminance level, and thus, a differential gain of a luminance level at which histogram data is locally concentrated can be reduced, and moreover, brightness fluctuations in a display portion which is heavily weighted in terms of visual perception can be suppressed, enabling a luminance control suitable for actual use.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing apparatus comprising:
an input unit wherein a luminance signal is input;
an obtaining unit configured to obtain histogram data for luminance levels of one frame of the luminance signal input to the input unit;
a frequency distribution unit configured to distribute a frequency of a histogram data among histogram data obtained by the obtaining unit for each luminance level, the histogram data being greater than a predetermined value, in a luminance level range set in advance for each luminance level, and to add the distributed frequency to the histogram data obtained by the obtaining unit and thereby obtains corrected histogram data units;
a creation unit configured to create a table for a nonlinear correction process to be used when performing a nonlinear correction process on the luminance signal input to the input unit based on the corrected histogram data corrected by the frequency distribution unit; and
a processing unit configured to perform a nonlinear correction process on the luminance signal input to the input unit based on the table for a nonlinear correction process created by the creation unit.

2. The video signal processing apparatus according to claim 1, wherein
the frequency distribution unit comprises:
a subtraction unit configured to subtract a threshold value which is set in advance for each luminance level, from its corresponding histogram data obtained by the obtaining unit;
a multiplication unit configured to multiply each subtracted value obtained from the subtraction unit by a weighted coefficient which is set in advance for each luminance level;
a distribution unit configured to distribute a frequency of each multiplied value obtained from the multiplication unit in the luminance level range which is set in advance for each luminance level; and
an addition unit configured to add each distributed frequencies obtained from the distribution unit to the histogram data obtained by the obtaining unit for each luminance level.

3. The video signal processing apparatus according to claim 2, wherein the subtraction unit outputs 0 when a subtraction result is negative.

4. The video signal processing apparatus according to claim 2, wherein the distribution unit distributes the frequency of each multiplied value obtained from the multiplication unit, in a luminance level range specified by a frequency distribution start value and a frequency distribution end value which are set in advance for each luminance level.

5. The video signal processing apparatus according to claim 4, wherein
when a multiplied value for a luminance level (i) obtained from the multiplication unit, is Dsub2 (i), the frequency distribution start value is Ws (i), and the frequency distribution end value is We (i), the distribution unit obtains a frequency to be distributed by:
Dsub2(i)/[We(i)−Ws(i)+1].

6. The video signal processing apparatus according to claim 2, wherein the distribution unit sets a luminance level range in which a frequency distribution is performed on a low luminance level to a range in which the luminance level is high, and sets a luminance level range in which a frequency distribution is performed on a high luminance level to a range in which the luminance level is low.

7. A video signal processing method comprising:
a first block of inputting a luminance signal;
a second block of obtaining histogram data for each luminance level of one frame of the luminance signal input in the first block;
a third block of distributing a frequency of a histogram data, among histogram data obtained in the second block for each luminance level, the histogram data being greater than a predetermined value, in a luminance level range set in advance for each luminance level, and adding the distributed frequency to the histogram data obtained in the second block for each luminance level and thereby obtaining corrected histogram data;
a fourth block of creating, based on the histogram data corrected in the third block, a table for a nonlinear correction process to be used when performing a nonlinear correction process on the luminance signal input in the first block; and
a fifth block of performing a nonlinear correction process on the luminance signal input in the first block based on the table for a nonlinear correction process created in the fourth block.

8. The video signal processing method according to claim 7, wherein
the third block comprises:
a subtraction block of subtracting a threshold value which is set in advance for each luminance level, from its corresponding histogram data obtained in the second block;
a multiplication block of multiplying each subtracted value obtained in the subtraction block by a weighted coefficient which is set in advance for each luminance level;
a distribution block of distributing a frequency of each multiplied value obtained in the multiplication block in the luminance level range which is set in advance for each luminance level; and
an addition block of adding each distributed frequencies obtained in the distribution block to the histogram data obtained in the second block for each luminance level.

9. The video signal processing method according to claim 8, wherein, in the subtraction block, 0 is output when a subtraction result is negative.

10. The video signal processing method according to claim 8, wherein, in the distribution block, the frequency of each multiplied value obtained in the multiplication block is distributed in a luminance level range specified by a frequency distribution start value and a frequency distribution end value which are set in advance for each luminance level.

11. The video signal processing method according to claim 10, wherein
when a multiplied value for a luminance level which is obtained in the multiplication block is Dsub2 (i), the frequency distribution start value is Ws (i), and the frequency distribution end value is We (i), in the distribution block a frequency to be distributed is obtained by:
Dsub2(i)/[We(i)−Ws(i)+1].

12. The video signal processing method according to claim 8, wherein, in the distribution block, a luminance level range in which a frequency distribution is performed on a low luminance level is set to a range in which the luminance level is high, and a luminance level range in which a frequency distribution is performed on a high luminance level is set to a range in which the luminance level is low.
